(19) United States
(12) Patent Application Publication
(10) Pub. No.: US 2020/0224546 A1
(43) Pub. Date: Jul. 16, 2020

(54) BIMETAL THERMO MECHANICAL ACTUATOR

(71) Applicant: SIEMENS AKTIENGESELLSCHAFT, München (DE)

(72) Inventors: Peter Szedlacsek, Winter Park, FL (US); Chao Ren, Shanghai (CN); Frederic Villeneuve, Oviedo, FL (US)

(21) Appl. No.: 16/341,088

(22) PCT Filed: Oct. 13, 2016
(86) PCT No.: PCT/US2016/056725

§ 371 Date: Apr. 11, 2019

(51) Int. Cl. F01D 11/18; F01D 11/02; F01D 25/24; F01D 5/14; F01D 5/20

(52) U.S. Cl. CPC F01D 11/18; F01D 11/025; F01D 25/246; F05D 2300/50212; F01D 5/20; F05D 2250/75; F01D 5/147

(57) ABSTRACT

A bimetal thermo mechanical actuator (10) includes a multi-layer bimetal structure (22) that includes a plurality of bimetal structures (12). Each bimetal structure (12) includes a pair of metals, a structural metal (14) and a driving metal (16) that are bonded together along a bonded interface (18) with the pair of metals forming one layer. A sliding interface (20) is between each pair of metals. The multi-layer bimetal structure (22) has a shape that has at least one arch. The multi-layer bimetal structure (22) includes a first end (24) and a second end (26), an inner edge (40) and an inner radius (42), an outer edge (44) and an outer radius (46). A first pivot head (28) is connected to the first end (24) and a second pivot head (34) is connected to the second end (26) of the multi-layer bimetal structure (22). Each pivot head includes a through-hole (30) located approximately center. The multi-layer bimetal structure (22) expands and contracts with temperatures changes.

### BACKGROUND

### 1. Field

The present invention relates to turbine engines, and more specifically to a bimetal thermo mechanical actuator within a turbine engine.

### 2. Description of the Related Art

In an industrial gas turbine engine, hot compressed gas is produced. The hot gas flow is passed through a turbine and expands to produce mechanical work used to drive an electric generator for power production. The turbine generally includes multiple stages of stator vanes and rotor blades to convert the energy from the hot gas flow into mechanical energy that drives the rotor shaft of the engine. Turbine inlet temperature is limited by the material properties and cooling capabilities of the turbine parts.

A combustion system receives air from a compressor and raises it to a high energy level by mixing in fuel and burning the mixture, after which products of the combustor are expanded through the turbine.

Gas turbines are becoming larger, more efficient, and more robust. Large blades and vanes are being produced, especially in the hot section of the engine system. These configurations have limitations as the blades require more robustness as the gas path diameters increase and the gas path temperatures increase.

A turbine blade, for example, is formed from a root portion coupled to a rotor disc and an airfoil that extends outwardly from a platform coupled to the root portion. The blade is ordinarily composed of a tip opposite the root section, a leading edge, and a trailing edge. A gap is formed between a stationary casing and the rotating blades in the gas path of the turbine. This gap allows for tip leakage flow. The tip leakage flow reduces the amount of torque generated by the turbine blades. A conventional combustor includes a transition, a vane, and seals. The compressor blade sees a gap or clearance area as well. These are just a few examples of where clearance is a concern with regards to efficiency.

The overall efficiency of a gas turbine engine depends on the minimum value of some critical clearances between the stationary and moving parts and between two moving parts. Gas turbines are manufactured with “cold built geometry” clearances that are selected to be large enough to accommodate any future variations due to mechanical and thermal deformations. This means that the geometry and final clearances are determined prior to use in operational conditions, and are set through the operation of the turbine engine. The mechanical and thermal deformations affect different clearances in different ways during the duty cycle. As a consequence of this, certain clearances are larger at base-load conditions (“hot running geometry”) than their achievable minimum and that is why overall engine efficiency is lower. The larger the clearance is at any point in time, the lower the overall efficiency. Currently, the clearances are controlled in a passive way as mentioned above. The “cold-built” clearance determines the “hot running” clearances at given operational conditions without the ability to adjust. Clearance throughout the gas turbine engine assembly effect the overall efficiency of the turbine engine.

### SUMMARY

In one aspect of the present invention, a bimetal thermo mechanical actuator comprises: a multi-layer bimetal structure comprising a plurality of bimetal structures, wherein each bimetal structure comprises a pair of metals, a structural metal and a driving metal, bonded together along a bonded interface, with the pair of metals forming one layer, wherein a sliding interface is between each pair of metals, wherein the multi-layer bimetal structure has a shape with at least one arch having a first end and a second end on opposite ends of a length of the multi-layer bimetal structure, an inner edge and inner radius, an outer edge and an outer radius; and a first pivot head connected to the first end and a second pivot head connected to the second end of the multi-layer bimetal structure, wherein each pivot head includes a through-hole located approximately center of each pivot head, wherein the multi-layer bimetal structure expands and contracts with temperature changes.

In another aspect of the present invention, a method for adjusting a clearance distance, comprises: positioning a bimetal thermo mechanical actuator between a stationary component and a moved component, the bimetal thermo mechanical actuator comprising: a multi-layer bimetal structure comprising a plurality of bimetal structures, wherein each bimetal structure comprises a pair of metals, a structural metal and a driving metal, bonded together along a bonded interface with the pair of metals forming one layer, wherein a sliding interface is between each pair of metals, wherein the multi-layer bimetal structure has a shape with at least one arch having a first end and a second end, an inner edge and inner radius, an outer edge and an outer radius; and a first pivot head connected to the first end and a second pivot head connected to the second end of the multi-layer bimetal structure, wherein each pivot head includes a through-hole located approximately center of each pivot head, wherein the multi-layer bimetal structure expands and contracts with temperature changes; mounting the first pivot head or the second pivot head to the moved component, wherein pivot head is mounted through the through-hole of the pivot head to the moved component; and increasing/decreasing a local temperature surrounding the bimetal thermo mechanical actuator, wherein the bimetal thermo mechanical actuator expands or contracts based on the direction of the temperature change, wherein the expansion or contraction of the bimetal thermo mechanical actuator moves the moved component along one axis closing a gap between two components.

These and other features, aspects and advantages of the present invention will become better understood with reference to the following drawings, description and claims.

### BRIEF DESCRIPTION OF THE DRAWINGS

The invention is shown in more detail by help of figures. The figures show preferred configurations and do not limit the scope of the invention.

FIG. 1 is a side view of a bimetal thermo mechanical actuator of an exemplary embodiment of the present invention.

FIG. 2 is a side view shown in a simplified wire frame of a bimetal thermo mechanical actuator at different temperatures of an exemplary embodiment of the present invention.

FIG. 3 is a perspective view of a bimetal thermo mechanical actuator of an exemplary embodiment of the present invention.

FIG. 4 is a side view of a bimetal thermo mechanical actuator of an exemplary embodiment of the present invention shown with only the inner and outer most layers for clarity.

FIG. 5 is a perspective view of a ring segment carrier and bimetal thermo mechanical actuator of an exemplary embodiment of the present invention.

FIG. 6 is side view of ring segment carrier rails and the bimetal thermo mechanical actuator of an exemplary embodiment of the present invention.

FIG. 7 is a perspective view of a multiple bimetal thermo mechanical actuators in a vane in an exemplary embodiment of the present invention.

FIG. 8 is a side view of a turbine vane labyrinth seal application for a bimetal thermo mechanical actuator in an exemplary embodiment of the present invention.

FIG. 9 is a side view of a bimetal thermo mechanical actuator with a heating/cooling element in an exemplary embodiment of the present invention.

### DETAILED DESCRIPTION

In the following detailed description of the preferred embodiment, reference is made to the accompanying drawings that form a part hereof, and in which is shown by way of illustration, and not by way of limitation, a specific embodiment in which the invention may be practiced. It is to be understood that other embodiments may be utilized and that changes may be made without departing from the spirit and scope of the present invention.

Broadly, an embodiment of the present invention provides a bimetal thermo mechanical actuator that includes a multi-layer bimetal structure that includes a plurality of bimetal structures. Each bimetal structure includes a pair of metals, a structural metal and a driving metal that are bonded together along a bonded interface with the pair of metals forming one layer. A sliding interface is there between each pair of metals. The multi-layer bimetal structure has a shape that has at least one arch. The multi-layer bimetal structure includes a first end and a second end, an inner edge and an inner radius, an outer ege and an outer radius. A first pivot head is connected to the first end and a second pivot head is connected to the second end of the multi-layer bimetal structure. Each pivot head includes a through-hole located approximately center. The multi-layer bimetal structure expands and contracts with temperatures changes.

A gas turbine engine may comprise a compressor section, a combustor and a turbine section. The compressor section compresses ambient air using a transition area, vanes, and seals. The combustor combines the compressed air with a fuel and ignites the mixture creating combustion products comprising hot gases that form a working fluid. The working fluid travels to the turbine section. Within the turbine section are circumferential alternating rows of vanes and blades, the blades being coupled to a rotor. Each pair of rows of vanes and blades forms a stage in the turbine section. The turbine section comprises a fixed turbine casing, which houses the vanes, blades and rotor.

Any leakage flow, or aerodynamic loss, that is not turned by the blades is lost work extraction, thus lowering the gas turbine engine efficiency. One area of concern is the flow between stationary and moving parts and between two moving parts. The lost flow that passes through the clearance between the stationary and moving parts contribute to a reduction in stage efficiency and power. Additional mixing losses occur when the flow through a tip clearance area combines with the main flow and the two streams have different velocities.

A reduction in loss based on a “hot running geometry” clearance between stationary and moving parts by providing an actuator that decreases the likelihood of flow coming up and through the clearance area and increases the likelihood of flow staying within the blade and vane passage is desirable. Embodiments of the present invention provide a bimetal thermo mechanical actuator for a compressor and turbine blade or vane that may allow for the reduction in losses. Examples are described below in regards to components within a gas turbine engine, however, the bimetal thermo mechanical actuator may be used in various other applications where movement can be measured by temperature differences.

Bimetals are metal structures that consist of two types of metals that are bonded together forming a sheet metal plate or strip. The coefficient of thermal expansion (CTE) of the two metals is different so that when the strip is exposed to a temperature change it bends because the metal with the smaller CTE becomes relatively shorter.

Bimetal applications have largely been for small, very light constructions suitable to work in electric circuits. In order to use bimetals as actuators in macroscopic mechanical structures, such as in typical gas turbine environment, several new features have to be developed as is described below. Embodiments of the present invention provide an inventive technique for accommodating changes in clearance for systems that have changes in temperature start through running, thus minimizing losses.

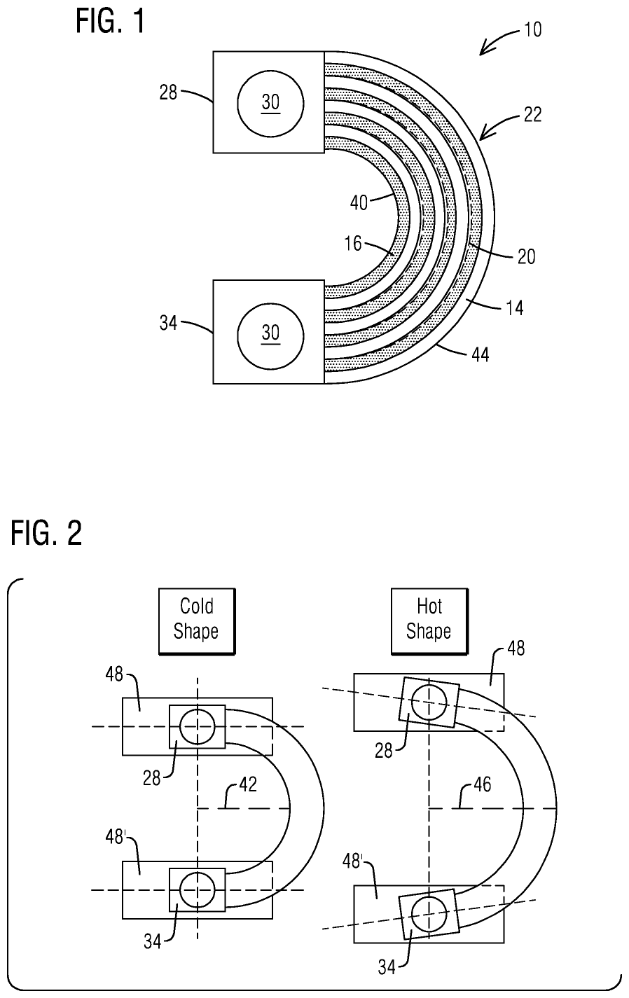

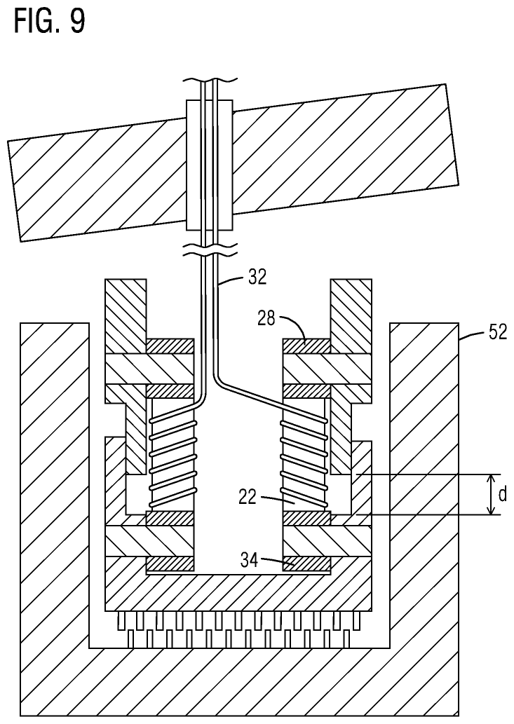

Referring to FIGS. 1 through 9, a bimetal thermo mechanical actuator (BTMA) 10 is shown. The BTMA 10 includes a plurality of bimetal structures 12. Each bimetal structure 12 includes a structural metal 14 and a driving metal 16 forming a strip. As mentioned above, the structural metal 14 and the driving metal 16 have different CTEs. The driving metal 16 is the metal that forces the movement of the BTMA 10. The structural metal 14 and the driving metal 16 strips are bonded together in pairs for a bonded interface 18 for each bimetal structure 12. The plurality of bimetal structures 12 are placed in layers with a sliding interface 20 between each bimetal structure 12 to produce a multi-layer bimetal structure (MLBS) 22. The MLBS 22 includes a first end 24 and a second end 26 that correlates to the ends of each bimetal structure 12.

The MLBS 22 may be manufactured with at least one bend or arch to its shape. The bent or arched shape of the plurality of bimetal structures 12 are limited only by the nature of the structure metal 14 and the driving metal 16 within each bimetal structure 12. Therefore, the MLBS 22 further includes an inner edge 40 and an inner radius 42 along with an outer edge 44 and an outer radius 46. The application as an actuator requires some angle to each strip, versus a standard flat/straight strip or plate. The arched structure may expand and/or contract due to temperature changes. The relative expansion of the arched structure active length is much larger than that of an initially linear structure. The quantity of the bimetal structures 12 can vary based on the requirements of the application. For example, depending on the overall strength required, distance of clearance gap, or other operational features.

FIG. 1 additionally shows a first pivot head 28 and a second pivot head 34 connected to the first end 24 and second end 26 of the MLBS 22 respectively. Both the first pivot head 28 and then second pivot head 34 includes a through-hole 30. The first pivot head 28, the second pivot head 34, or the first pivot head 28 and second pivot head 34 may then be mounted to a moving or moved component 48. Various examples of applications are further detailed below.

FIG. 2 illustrates a cold shape and cold active height and a hot shape and a hot active height. FIG. 2 is shown with a simplified wire frame to more clearly show the details described. The metal with the lower CTE is shown on the outer edge while the metal with the higher CTE is shown on the inner edge of the bimetal structure. FIG. 2 shows the bimetal structure 12 in this configuration, however, in other embodiments the lower CTE metal and the higher CTE metal positions are switched based on the requirements of the application. An example is if while in service, temperatures decrease, then the bimetal structure 12 will contract. The benefit of including the first pivot head 28 and the second pivot head 34 to the BTMA 10 is that the component 48 that each pivot head is mounted to may only move in a vertical direction along one axis. As can be seen in FIG. 2 on the hot shape figure on the right, each pivot head may rotate as the MLBS 22 expands, thereby allow the moving component 48 to move only in the direction it is meant to move. Without the first pivot head 28 and the second pivot head 34, the moving component 48 would be forced to rotate out of position by the force of the MLBS 22 if it were attached directly.

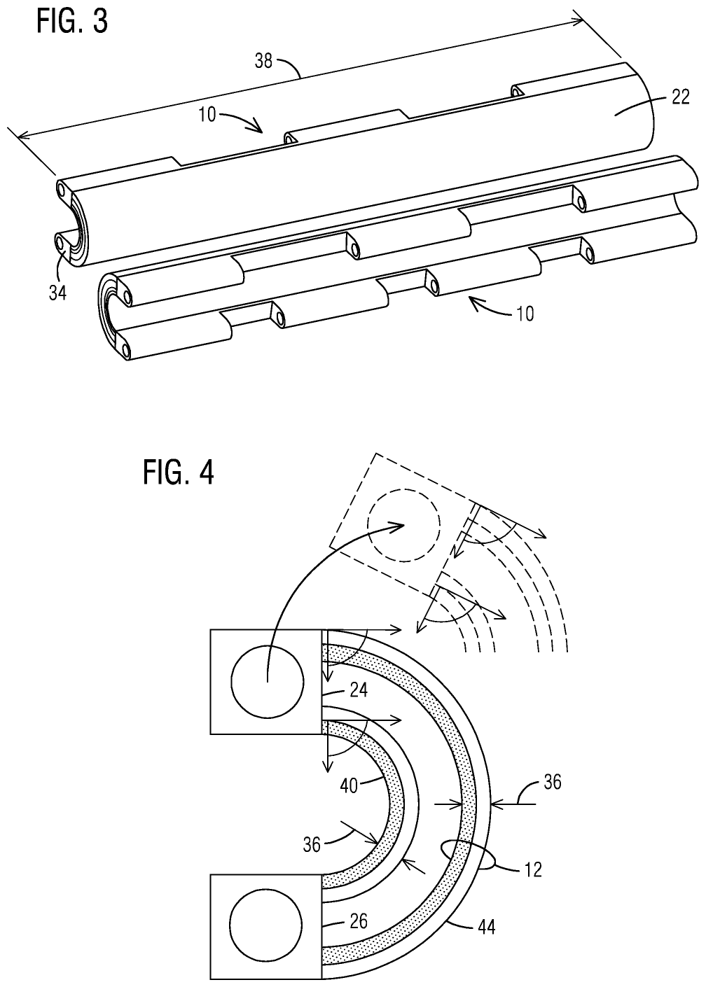

In certain embodiments, the MLBS 22 enables each embodiment to be manufactured to the desired strength. Relative displacement is different for different radii. The radii of the MLBS 22 at a cold state and their relative expansion from cold to hot active length are different as seen in FIGS. 2 and 4. The thicknesses of each layer, or bimetal structure 12, are scaled so that their relative expansion will decrease with the increasing radius. In this way, the connecting angles formed between each pivot head and the MLBS 22 may not change during expansion. In this way the residual stress between the MLBS 22 and each pivot head may be minimized. For clarity, FIG. 3 illustrates the differences in thicknesses of the extreme outer pairing and the extreme inner pairing of bimetal structures 12. As is shown, the extreme inner pairing has a different thickness over the pairings as the radius of the pairing increases. The varying of thicknesses may minimize the strain in the MLBS 22 and between each bimetal structure 12 layer and each pivot head 28, 34. In certain embodiments, each of the plurality of bimetal structures 12 may have different driving metals 16 and structural metals 14 than the other bimetal structures 12 within the MLBS 22.

Actuators for a gas turbine engine environment should have a certain strength that requires robust structures. Increasing the thickness of one bimetal structure is not an option because the range of relative deformation decreases quickly by increasing the thickness. The BTMA 10 includes the plurality of bimetal structures 12 for a multi-layer bimetal structure 22 that can be scaled to any mechanical requirement.

The bimetal thermo mechanical actuator 10 may be used in various situations based on the desired needs of the service. The MLBS 22, as a part of the BTMA 10, should be strong enough to provide driving force to the connected components 48.

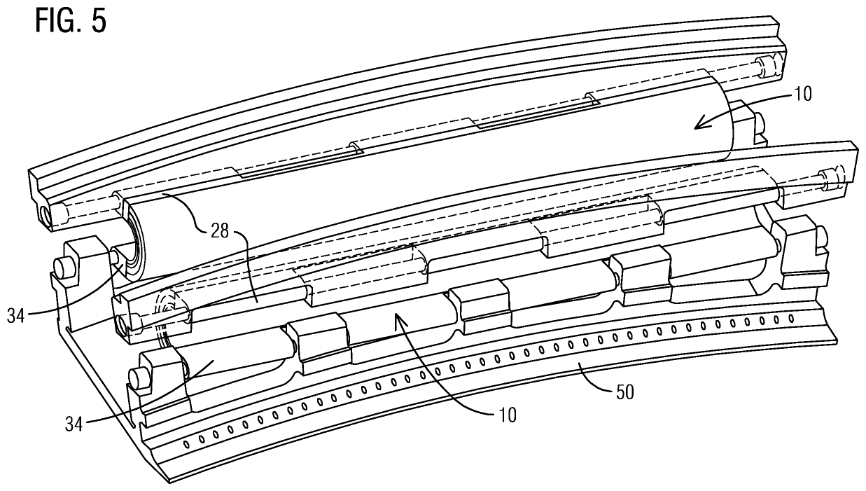

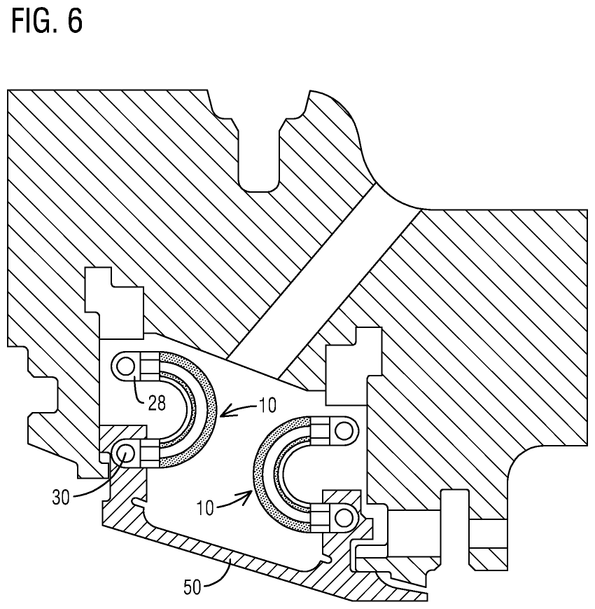

Several examples will be listed here, however, this is not an exhaustive list of applications for the bimetal thermo mechanical actuator. The BTMA 10 may be mounted to a gas turbine frame and a moved component 48 that controls the effective area of a flow channel. FIGS. 5 and 6 illustrate the bimetal thermo mechanical actuator 10 in a ring segment carrier 50. The gap between a tip of a blade and the ring segment 50 in a turbine is an important driver for turbine efficiency. The blade (not shown) would be below the ring segment 50 with the flow of gas, F, in between the two components as shown. The expansion of the BTMA 10 may move the ring segment 50 downward towards the blade thereby closing the gap between the two components 48.

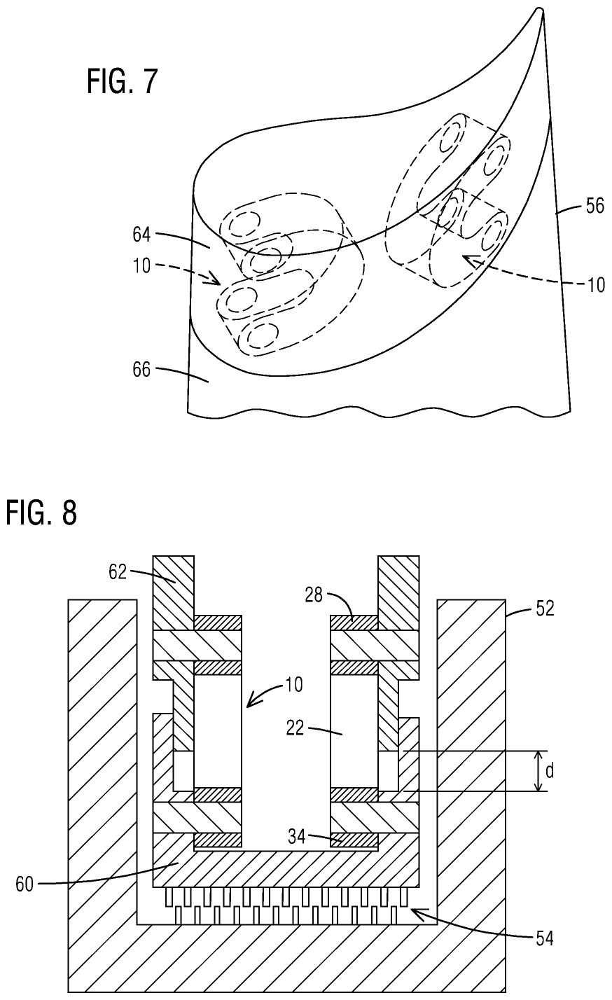

There can be multiple bimetal thermo mechanical actuators 10 within an application. An example of this may be a BTMA 10 in a compressor vane 56 as shown in FIG. 7. Two BTMAs 10 may work in parallel positioned close to an upper part 64 of the vane 56. In this embodiment, the upper part 64 of the vane 56 is a separate part that fits into a lower part 66 and may be positioned with sliding grooves 68 in the vertical direction. The upper part 64 may only move in the vertical direction due to the grooves 68. The lower part 66 and the upper part 64 may be connected by two BTMAs 10. The vane 56 may be heated up at base load. Each BTMA 10 may expand and close the tip clearance. At shut down, the BTMA 10 may cool down and contract making the vane 56 shorter again to avoid “pinching”. The process may be reversible and may be controlled by proper cooling flow through the vane 56.

FIG. 8 illustrates another application of the bimetal thermo mechanical actuator 10. This application is a turbine vane labyrinth seal 54 with the bimetal thermo mechanical actuator 10. A bottom portion 60 of the labyrinth seal 54 shown may be moved by the BTMA 10 reversely in the radial direction with changes in temperature. A top portion 62 of the labyrinth seal 54 may be connected to the bottom portion 60 of the turbine vane 52. The seal 54, segmented properly, allows for the bottom portion 60 to be moved by the BTMA 10 reversely in the radial direction by a distance, d.

The BTMA 10 may be controlled by a local temperature and the BTMA 10 may be designed to provide the exact thermal expansion or contraction that may be needed at any specific location. There are locations where the temperatures are determined by the cooling flows and the cooling mass flow rates are determined by fixed cross sections and orifices. The BTMA 10 may be used to control the effective cross sectional areas of the cooling flow channels in function of the cooling flow temperature. The BTMA 10 may work as a temperature actuated valve in these situations. In this way a two level control may be applied. First a cooling air mass flow may be controlled with the BTMA 10 and then resulting local temperature may control the second BTMA 10 that controls a clearance. In this way the clearances may have a more refined control in the function of time during the duty cycle.

In certain situations the local temperature may not be suitable to control the BTMA 10 because of the range or the temperature as a function of time is not appropriate. An embodiment of the BTIVIA 10 may include a heating/cooling element 32 that may provide control temperature that is independent of the local gas or metal temperatures. The heating/cooling element 32 may be, but not limited to, a heating/cooling coil, or the like. The heating/cooling element 32 may likely be electric in nature.

Embodiments of the BTMA 10 are built to have the ability to deform as much as possible and with precision based on operational conditions. The BTMA 10 has to be strong enough to withstand the operating conditions, within the gas turbine engine as an example. The BTMA 10 also has to be strong enough to be able to move the moved component 48 with expansion. The multi-layer bimetal structure 22 allows for a stronger overall structure due to the arch and plurality of bimetal structures 12. Additionally, having the first pivot head 28 and the second pivot head 34 allows the MLBS to expand without the added pressure of the fixed connection to a moved component. Further, because the MLBS is separated from the moved component 48 by the first pivot head 28 and the second pivot head 34, there is no deformation of the component 48 since there is rotation around each pivot head instead of an angled movement.

The multi-layer bimetal structure 22 may be bent or arched in at least one place such as in a semi-circle shape, a shape that has multiple curves such as an “S” shape or something similar, a shape that is bent in multiple directions, or the like. As long as the multi-layer bimetal structure 22 allows for the expanding and contraction of the bimetal thermo mechanical actuator 10 when in a space of changing temperatures, and is initially bent or arched in at least one part, the bimetal thermo mechanical actuator 10 may function as intended.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

1. A bimetal thermo mechanical actuator comprising:
a multi-layer bimetal structure comprising a plurality of bimetal structures, wherein each bimetal structure comprises a pair of metals, a structural metal and a driving metal, bonded together along a bonded interface, with the pair of metals forming one layer, wherein a sliding interface is there between each pair of metals, wherein the multi-layer bimetal structure has a shape with at least one arch having a first end and a second end on opposite ends of a length of the multi-layer bimetal structure, an inner edge and inner radius, an outer edge and an outer radius; and
a first pivot head connected to the first end and a second pivot head connected to the second end of the multi-layer bimetal structure, wherein each pivot head includes a through-hole located approximately center of each pivot head,
wherein the multi-layer bimetal structure expands and contracts with temperature changes.

2. The bimetal thermo mechanical actuator according to claim 1, wherein each bimetal structure varies in thickness compared to other bimetal structures within the multi-layer bimetal structure.

3. The bimetal thermo mechanical actuator according to claim 1, wherein the multi-layer bimetal structure is bent in an approximately semi-circle shape.

4. The bimetal thermo mechanical actuator; according to claim 1, wherein the multi-layer bimetal structure is bent in a shape that has multiple curves.

5. The bimetal thermo mechanical actuator according to claim 1, wherein the multi-layer bimetal structure is bent in multiple directions.

6. The bimetal thermo mechanical actuator according to claim 1, further comprising a heating/cooling element attached to the multi-layer bimetal structure.

7. A method for adjusting a clearance distance, comprising:
positioning a bimetal thermo mechanical actuator between a stationary component and a moved component, the bimetal thermo mechanical actuator comprising:
a multi-layer bimetal structure comprising a plurality of bimetal structures, wherein each bimetal structure comprises a pair of metals, a structural metal and a driving metal, bonded together along a bonded interface with the pair of metals forming one layer, wherein a sliding interface is between each pair of metals, wherein the multi-layer bimetal structure has a shape with at least one arch having a first end and a second end, an inner edge and inner radius, an outer edge and an outer radius; and
a first pivot head connected to the first end; and a second pivot head connected to the second end of the multi-layer bimetal structure, wherein each pivot head includes a through-hole located approximately center of each pivot head,
wherein the multi-layer bimetal structure expands and contracts with temperature changes;
mounting the first pivot head or the second pivot head to the moved component, wherein pivot head is mounted through the through-hole of the pivot head to the moved component; and
increasing/decreasing a local temperature surrounding the bimetal thermo mechanical actuator, wherein the bimetal thermo mechanical actuator expands or contracts based on the direction of the temperature change, wherein the expansion or contraction of the bimetal thermo mechanical actuator moves the moved component along one axis closing a gap between two components.

8. The method according to claim 7, wherein the moved component is a gas turbine compressor vane, wherein one pivot head mounts in a lower part of the gas turbine compressor vane and the other pivot head mounts to a moving upper part of the vane.

9. The method according to claim 7, wherein the moved component is a gas turbine vane, wherein one pivot head mounts in the gas turbine vane and the other pivot head mounts to a moving top of the turbine vane.

10. The method according to claim 7, wherein the stationary component is a gas turbine frame, wherein one pivot head mounts to the gas turbine frame and the other pivot head mounts to the moved component.
